(19) United States
(12) Patent Application Publication
(10) Pub. No.: US 2025/0391435 A1
(43) Pub. Date: Dec. 25, 2025

(54) INTERFACE VOLTAGE CONTROL FOR SLIDER IN DATA STORAGE DEVICE

(71) Applicant: Western Digital Technologies, Inc., San Jose, CA (US)

(72) Inventors: Shuntaro Takeuchi, Fujisawa (JP); Suttisak Nilchim, Ayutthaya (TH); Toshiya Shiramatsu, Fujisawa (JP); Mitsuhiro Shoda, Fujisawa (JP); Risa Suzuki, Fujisawa (JP)

(21) Appl. No.: 18/749,611

(22) Filed: Jun. 21, 2024

(51) Int. Cl. G11B 5/60; G11B 5/00; G11B 5/012; G11B 5/02

(52) U.S. Cl. CPC G11B 5/607; G11B 5/012; G11B 5/02; G11B 5/6035; G11B 5/6076; G11B 5/6094; G11B 2005/0021

(57) ABSTRACT

A Data Storage Device (DSD) comprises a magnetic disk and a slider including a writer configured to magnetically write data on the magnetic disk. A voltage is applied to the slider to provide a target offset voltage between the slider and the magnetic disk with the applied voltage differing from a disk voltage of the magnetic disk. In one aspect, a first disk voltage is determined for the magnetic disk. The voltage to be applied to the slider is determined to adjust an electric potential difference between the slider and the disk to the non-zero target offset voltage. In another aspect, the voltage applied to the slider is less than the disk voltage and reduces deterioration of the slider caused by operation of an energy-assisted magnetic recording technology at the slider while maintaining a safe fly height of the slider over the magnetic disk.

### BACKGROUND

Data Storage Devices (DSDs) are often used to record data onto or to reproduce data from storage media. One type of storage media includes a rotating magnetic disk, such as in a Hard Disk Drive (HDD). In such DSDs, a slider including read and write transducers is typically positioned in relation to a magnetic disk to magnetically read and write data in a recording layer the surface of the magnetic disk. The slider is attached to an actuator arm by a suspension and positioned very close to the disk surface by the suspension (e.g., within five nanometers). There is typically a stack of disks in the DSD with a slider-suspension assembly associated with each disk surface in the stack.

The separation or spacing between the slider and the disk surface is called the fly height. The slider has a disk-facing Gas-Bearing Surface (GBS) that causes the slider to ride on a cushion or bearing of gas, typically air or helium, generated by rotation of the disk. The slider is attached to a flexure on the suspension and the suspension includes a load beam that applies a load force to the slider to counteract the gas-bearing force while permitting the slider to “pitch” and “roll.” The flying dynamics of the slider, and thus the fly height, are influenced by factors such as the rotation speed of the disk, the aerodynamic shape of the slider's GBS, the load force applied to the slider by the suspension, and the pitch and roll torques applied to the slider by the suspension.

Interface Voltage Control (IVC) is used to apply a voltage to the slider body or to the disk. In some instances, IVC may be used to passivate the slider by encapsulating at least a portion of the slider body with a static electrical charge, which can help preserve the life of the slider and its components by protecting it from mechanical wear, as well as from chemical oxidation. IVC may also be used to minimize the slider-disk electric potential difference. When the slider-disk electric potential difference is not cancelled completely, an attractive electrostatic force pulls the slider towards the disk, which may cause contact between the slider and the disk and/or the slider to pick-up or accumulate disk lubricant from the disk surface. Oftentimes, the accumulation of lubricant from the disk surface can reduce the performance of the slider, such as by interfering with the slider's ability to accurately read or write data.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a plan view of an example Data Storage Device (DSD) according to one or more embodiments.

FIG. 2A illustrates different interface voltages between a slider and a magnetic disk.

FIG. 2B is a graph showing the change in the fly height of the slider of FIGS. 2A over the magnetic disk as the interface voltage changes.

FIG. 3 is a block diagram of a slider coupled to a slider bias voltage generator according to one or more embodiments.

FIG. 4 is a graph showing a voltage applied to a slider over time to maintain a target offset voltage between the slider and a varying disk voltage according to one or more embodiments.

FIG. 5 is a graph showing an average voltage applied to sliders in a DSD over a long timeframe to maintain a target offset voltage between the sliders and an average disk voltage according to one or more embodiments.

FIG. 6 is a flowchart for an initial slider voltage setting process according to one or more embodiments.

FIG. 7 is a flowchart for a repeating slider voltage setting process according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example Data Storage Device

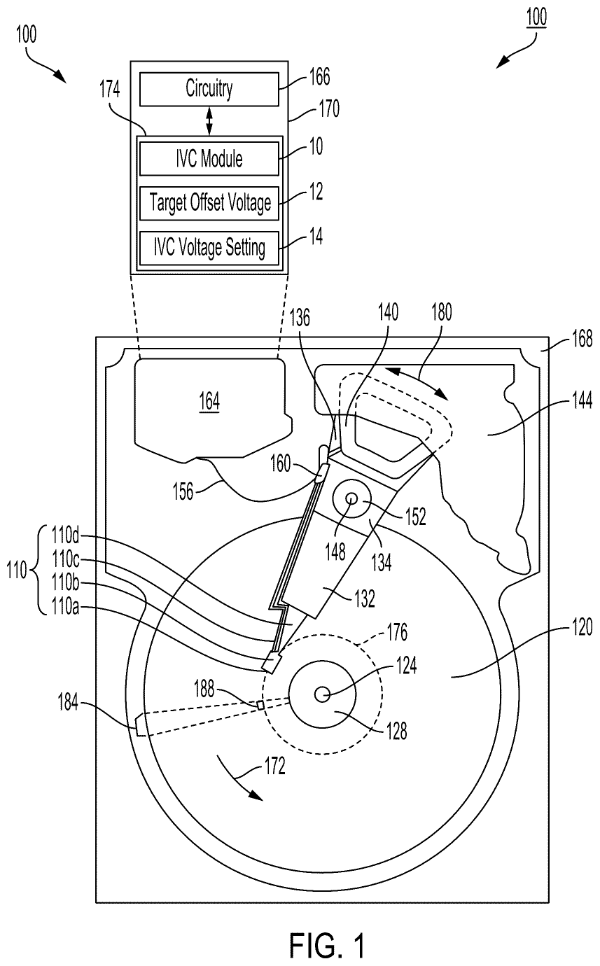

FIG. 1 is a plan view of example Data Storage Device (DSD) 100 according to one or more embodiments to illustrate an exemplary operating environment. In some implementations, DSD 100 can include a Hard Disk Drive (HDD) or other type of DSD including a magnetic disk as a data recording medium, such as a Solid-State Hybrid Drive (SSHD) that can include solid-state non-volatile memory in addition to one or more magnetic disks.

As shown in the example of FIG. 1, DSD 100 includes slider 110b that includes magnetic reading/recording head 110a. Collectively, slider 110b and head 110a may be referred to as a head slider. DSD 100 further includes at least one Head Gimbal Assembly (HGA) 110 including the head slider, lead suspension 110c attached to the head slider typically via a flexure, and load beam 110d attached to lead suspension 110c.

DSD 100 also includes at least one magnetic disk 120 rotatably mounted on spindle 124 and a drive motor (not visible) attached to spindle 124 for rotating magnetic disk 120. Head 110a includes a writer or write element and a reader or read element for respectively writing and reading data stored on magnetic disk 120 of DSD 100. Magnetic disk 120 or a plurality of magnetic disks stacked below magnetic disk 120 may be affixed to spindle 124 with disk clamp 128.

As shown in FIG. 1, DSD 100 further includes arm 132 attached to HGA 110, carriage 134, a Voice-Coil Motor (VCM) that includes armature 136 and voice coil 140 attached to carriage 134 and stator 144 including a voice-coil magnet (not visible). Armature 136 of the VCM is attached to carriage 134 and is configured to move arm 132 and HGA 110, to access portions of magnetic disk 120, being mounted on pivot shaft 148 with interposed pivot-bearing assembly 152. In the case of multiple disks, carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a Head Stack Assembly (HSA). An HSA may, however, include more or fewer components than those described. For example, an HSA may refer to an assembly that further includes electrical interconnection components. Generally, an HSA is the assembly configured to move the head slider to access portions of the magnetic disk 120 for read and write operations.

With further reference to FIG. 1, electrical signals (e.g., current to voice coil 140 of the VCM) comprising a write signal to and a read signal from head 110a, are provided by flexible interconnect cable 156 (“flex cable”). Arm-Electronics (AE) module 160, which may have an on-board pre-amplifier for the read signal, as well as other read-channel and write-channel electronic components, provides connection between flex cable 156 and head 110a. AE module 160 may be attached to carriage 134 as shown or may be included as part of circuitry 166 of controller 170. Flex cable 156 is coupled to electrical connector block 164, which provides electrical communication to controller 170 located beneath electrical connector block 164 through electrical feedthroughs provided by housing 168. Housing 168, also referred to as a base, in conjunction with a cover provides a sealed, protective enclosure for the data storage components of DSD 100.

Other electronic components, including a disk controller and servo electronics that can further include a Digital Signal Processor (DSP), provide electrical signals to the drive motor, voice coil 140 of the VCM and head 110a of the HGA 110. The electrical signal provided to the drive motor enables the drive motor to spin providing a torque to spindle 124, which is in turn transmitted to magnetic disk 120 that is affixed to spindle 124. As a result, magnetic disk 120 spins in a direction 172. The magnetic disk 120 creates a cushion of gas that acts as a gas-bearing on which the Gas-Bearing Surface (GBS) of slider 110b rides so that slider 110b flies above the surface of magnetic disk 120 without contacting a thin magnetic-recording layer of disk 120 in which data is recorded.

The electrical signal provided to voice coil 140 of the VCM enables head 110a of HGA 110 to access a track 176 in which data is recorded. Thus, armature 136 of the VCM swings through an arc 180, which enables head 110a of HGA 110 to access various tracks on magnetic disk 120. Data is stored on magnetic disk 120 in a plurality of radially nested tracks arranged in sectors on magnetic disk 120, such as sector 184. Correspondingly, each track is composed of a plurality of sectored track portions (or “track sectors”), for example, sectored track portion 188. Each sectored track portion may store recorded data and a header containing a servo-burst-signal pattern, for example, an ABCD-servo-burst-signal pattern, which is information that identifies track 176, and error correction code information. In accessing track 176, the read element of head 110a of HGA 110 reads the servo-burst-signal pattern, which provides a Position-Error-Signal (PES) to the servo electronics, which controls the electrical signal provided to voice coil 140 of the VCM, enabling head 110a to follow track 176. Upon finding track 176 and identifying sectored track portion 188, head 110a either reads data from track 176 or writes data to track 176 depending on instructions, such as instructions received by controller 170 from an external host, such as a microprocessor of a computer system.

In the example of FIG. 1, controller 170 is shown with dashed lines connected to electrical connector block 164 to indicate that controller 170 is in electrical communication with electrical connector block 164. As will be appreciated by those of ordinary skill in the art, controller 170 in some implementations can include a Printed Circuit Board (PCB) coupled to the bottom side of DSD 100, such as to housing 168. As shown in the example of FIG. 1, controller 170 includes circuitry 166 and at least one Non-Volatile Memory (NVM) 174.

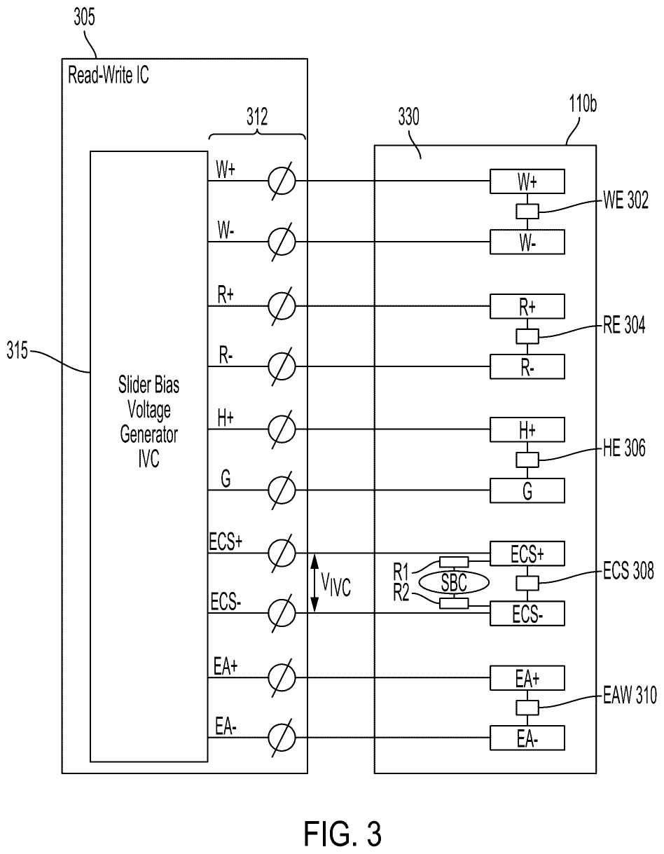

Circuitry 166 can comprise electronic components for performing different functions for operation of the DSD, such as an interface controller, a Read/Write Integrated Circuit (R/W IC) (e.g., R/W IC 305 in FIG. 3), an AE module, a motor driver, a servo processor, and other digital processors and associated memory. In this regard, circuitry 166 can include one or more processors for executing instructions, such as a microcontroller, a DSP, an Application-Specific Integrated Circuit (ASIC), a Field Programmable Gate Array (FPGA), hard-wired logic, analog circuitry and/or a combination thereof. In some implementations, circuitry 166 can include a System on a Chip (SoC), which may also include one or more memories of NVM 174.

As shown in FIG. 1, at least one NVM 174 stores Interface Voltage Control (IVC) module 10, target offset voltage 12, and IVC voltage setting 14. As discussed in more detail below, circuitry 166 can execute IVC module 10 to apply a voltage based on IVC voltage setting 14 to slider 110b to reach a target offset voltage between slider 110b and magnetic disk 120, which can be represented by target offset voltage 12. IVC module 10 may form part of a firmware for DSD 100 that is executed by circuitry 166 to control operation of DSD 100.

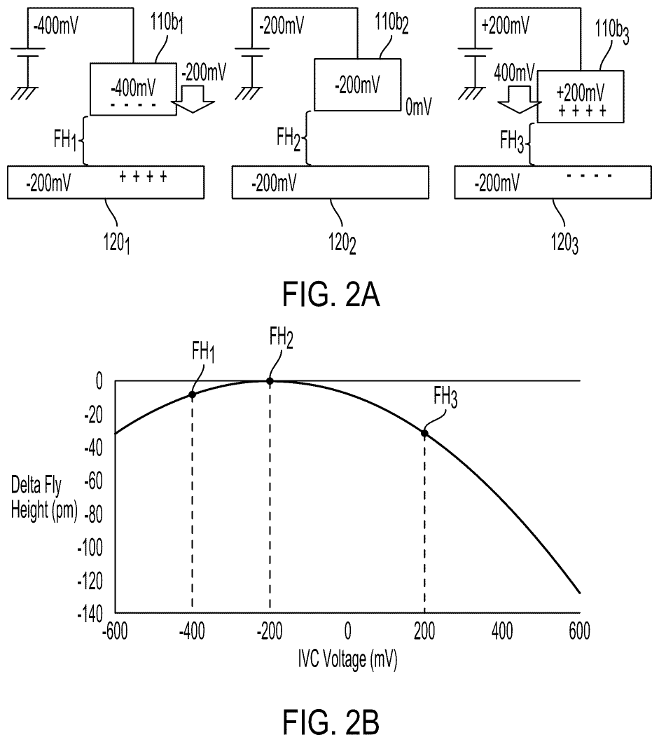

In conventional DSDs with a magnetic disk, an IVC may apply an “Optimum Interface Voltage” (OIV) to the slider so that a voltage of the slider matches the voltage of the disk to cancel out or minimize the potential difference between the slider and the disk. As discussed in more detail below with reference to FIGS. 2A and 2B, the OIV applied to the slider eliminates the attractive electrostatic force between the slider and the disk to provide a highest fly height between the disk and the slider and thereby reduces the risk of the slider contacting or crashing onto the disk surface and/or accumulating lubricant from the disk surface, which can reduce the performance and/or a usable life of the slider.

Unlike such conventional DSDs, the present disclosure maintains a target offset voltage between the voltage of the slider and the voltage of the magnetic disk, or the conventional OIV, by applying a voltage to the slider that is less than the disk voltage. The voltage applied to the slider can increase the usable life of the slider by passivating the slider or encapsulating at least a portion of the slider with a static electrical charge that can help preserve the life of the slider and its components by protecting the slider from mechanical wear and/or chemical oxidation. Such mechanical wear or deterioration has been found to be especially problematic for sliders that use newer Energy-Assisted Magnetic Recording (EAMR) technologies. Examples of such EAMR technologies can include, for example, Microwave-Assisted Magnetic Recording (MAMR), energy-assisted Perpendicular Magnetic Recording (ePMR), and Heat-Assisted Magnetic Recording (HAMR).

As will be appreciated by those of ordinary skill in the art with reference to the present disclosure, other implementations of DSD 100 may differ from the example shown in FIG. 1. For example, other implementations of DSD 100 can include additional types of storage media in addition to one or more magnetic disks, such as a non-volatile solid-state memory. As another example variation, target offset voltage 12 and IVC voltage setting may be stored in the same data structure.

FIG. 2A illustrates three different example interface voltages between slider 110b and magnetic disk 120 to illustrate the attractive electrostatic force when there is a difference between a voltage of magnetic disk 120 and slider 110b.

In the leftmost example shown in FIG. 2A, a −400 mV voltage is applied to slider 110b₁, which results in a −200 mV potential difference between the −200 mV voltage of magnetic disk 120₁ and the −400 mV voltage applied to slider 110b₁. This results in an attractive electrostatic force between the slider and the magnetic disk, as shown by the arrow pointing down from slider 110b₁ towards disk 120. This electrostatic force affects the fly height of slider 110b₁ over magnetic disk 120₁, which has a fly height of FH₁.

In the middle example shown in FIG. 2A, a −200 mV voltage is applied to slider 110b₂, which results in a 0 mV potential difference between the −200 mV voltage of magnetic disk 120₂ and the −200 mV voltage applied to slider 110b₂. This results in little to no attractive electrostatic force between the slider and the magnetic disk. At this matching voltage, which is conventionally referred to as the OIV, the fly height of slider 110b₂ is at its greatest fly height, FH₂. This fly height is represented with FH₂ at the maximum of the curve in FIG. 2B, which is a graph showing the change in the fly height of slider 110b as the IVC voltage applied to slider 110b changes. As shown in FIG. 2B, the delta fly height measured in picometers (pm) increases from FH₁ with an IVC voltage of −400 mV applied to slider 110b₁ to the maximum fly height having an offset of 0 pm.

In the rightmost example shown in FIG. 2A, a +200 mV voltage is applied to slider 110b₃, which results in a 400 mV potential difference between the −200 mV voltage of magnetic disk 120₃ and the 200 mV voltage applied to slider 110b₃. This results in a stronger attractive electrostatic force between the slider and the magnetic disk, as shown by the arrow pointing down from slider 110b₃ to magnetic disk 120₃. This attractive force results in a reduced fly height FH₃, which is also shown on the curve in FIG. 2B at an IVC voltage of 200 mV with a larger magnitude in the delta fly height from FH₂.

As noted above, the present disclosure applies an IVC voltage to the slider to improve the usable life of the slider, but also seeks to maintain a target offset voltage between the disk voltage and the IVC voltage to keep the attractive electrostatic force within a safe range to reduce the risk of an undesired contact between the slider and the disk and/or accumulation of lubricant from the disk surface onto the slider. The IVC voltage applied to the slider can be controlled to provide a voltage that is less than a determined disk voltage by the target offset voltage. In some implementations, the target offset voltage can have a magnitude within a range of 100 mV and 700 mV such that the IVC voltage applied to the slider is between 100 mV and 700 mV less than the disk voltage. For example, an IVC voltage may be applied to the slider to provide an interface voltage between the slider and the disk (i.e., the potential difference between the slider voltage and the disk voltage) that substantially matches a target offset voltage of −600 mV to prolong the life of the slider, while keeping the fly height a relatively safe distance.

FIG. 3 is a block diagram of slider 110b coupled to slider bias voltage generator 315 in R/W IC 305 according to one or more embodiments. Slider bias voltage generator 315 functions as IVC circuitry and generates a Direct Current (DC) bias voltage to an element and/or the structure of slider 110b via an existing signal path, which in the example of FIG. 3 is the signal path to Embedded Contact Sensor (ECS) 308.

In the example of FIG. 3, slider 110b comprises a conductive body 330 and includes Write Element (WE) 302, Read Element (RE) 304, Heater Element (HE) 306, ECS 308, and Energy-Assisted Writer (EAW) 310. In some implementations, EAW 310 can have a HAMR, MAMR, or ePMR configuration to improve magnetic writing on the disk.

In FIG. 3, slider bias voltage generator 315 is shown as a portion of R/W IC 305, which may form a part of circuitry 166 of controller 170 in FIG. 1. In other implementations, slider bias voltage generator 315 can form part of other circuitry of DSD 100 located outside of controller 170 in FIG. 1. For example, slider bias voltage generator 315 may be included as part of AE module 160 in FIG. 1 attached to carriage 134 in some implementations.

A signal path exists between R/W IC 305 and each of WE 302, RE 304, HE 306, ECS 308, and EAW 310. R/W IC 305 includes a plurality of R/W IC input/outputs (I/Os) 312. The I/Os 312 may, for example, include pads for electrical connection via existing signal paths to corresponding pads on the top of slider 110b. R/W IC input/outputs 312 in FIG. 3 include: write+ (W+) and write− (W−), read+ (R+) and read− (R−), heater element control+ (H+) and ground (G), ECS+ and ECS−, and EAW+ and EAW−.

WE 302 can include a writer coil that is part of a writer including a main pole, a trailing magnetic shield, and a return pole 258 connected to the trailing shield. The main pole is exposed at the GBS of slider 110b and faces the disk. Electric current flowing through WE 302 produces a magnetic field that emits from the tip of the main pole and forms recording bits by reversing the magnetization of magnetic regions on the disk. WE 302 is connected to write head contact pads W+, W− on slider 110b. The return pole is positioned for returning the magnetic flux from the disk to the writer structure to complete a magnetic circuit. The magnetic trailing shield is typically positioned between the main pole and the return pole for assisting with focusing the magnetic flux emitting from the main pole.

RE 304 can include a read sensor, typically a magneto-resistive sensor, located between two soft magnetic shields, and is connected to contact pads R+, R− on slider 110b. RE 304 provides a read signal to R/W IC 305 that is used to read the data stored on the disk.

HE 306 is controlled by a TFC device (not shown), which is connected to HE 306 at pads H+ and G on slider 110b. By applying current to HE 306, the surrounding slider material expands in response to heat generated by HE 306, which causes a bulge in slider 110b toward the disk, thus reducing the fly height. This reduced fly height can be controlled to achieve a greater data storage density when writing data and also to reduce variation in the fly height while writing and reading data. During write operations, heat from HE 306 causes the main pole and trailing shield of the writer to be closer to the disk 120 to enable the written magnetic bits to be placed closer together on the disk. In this regard, HE 306 and its associated TFC can be a form of EAMR that can cause increased deterioration to slider 110b.

ECS 308 can include a metallic strip located at the GBS of slider 110b and is connected to contact pads ECS+ and ECS− on slider 110b. The resistance of the ECS changes in response to temperature changes and can be used to detect slider-disk contact when the slider temperature suddenly increases due to frictional heating from the disk.

In some implementations, the ECS signal or the read signal from RE 304 can be used to determine a voltage to apply to the slider by indirectly measuring a fly height of the slider. For example, a series of input voltages can be applied by slider bias voltage generator 315 within a range of voltages (e.g., within voltage limits 20 and 22 in FIG. 2B or between 1V and −1V) while slider 110b flies over the disk. Head-disk spacing signals are then monitored by circuitry of DSD 100 (e.g., R/W IC 305) from ECS 308 or from RE 304 using Wallace spacing loss signals or dual harmonic sensing, as described in U.S. Patent Application Publication No. 2014/0240871, which is assigned to the present applicant and hereby incorporated by reference herein. Based on the relation between the spacing signal values and the series of input voltages, an IVC operating point or IVC voltage setting (e.g., IVC voltage setting 14 in FIG. 1) for the voltage to be applied to the slider is identified that corresponds to the target offset voltage (e.g., target offset voltage 12 in FIG. 1).

In the example of FIG. 3, where the IVC is provided via the ECS, slider 110b includes resistive components R1 and R2 coupled between a Slider Body Connection (SBC), and each leg of the signal path between the ECS and R/W IC 305. This provides a common mode signal path, which couples the applied voltage or the slider bias voltage to slider 110b. With this connection scheme, the ECS common-mode voltage V_{ECS-CM} is equivalent to (V_{ECS-}+V_{ECS+})/2 and can be used to control the potential of slider 110b relative to the disk.

While FIG. 3 illustrates an embodiment where the existing signal path is the ECS signal path, the existing signal path can include any of the write signal path, the read signal path, the heater element control signal path, the energy-assisted writer path, or the ECS path. By “existing signal path,” what is meant is that a conventional existing signal path, such as a read path, write path, heater element control path, energy-assist signal path, or ECS path is utilized for coupling bias voltage generator 315 to slider 110b. While an existing signal path may be slightly modified, such as through the inclusion of components such as a capacitor, a coupling to a slider body connection, and/or one or more resistors, a separate special purpose signal path for coupling the slider IVC voltage from slider bias voltage generator 315 to slider 110b is not required. The existing signal path is primarily used for conveying another signal (e.g., a read data signal, write data signal, heater element control signal, energy-assist signal, or ECS signal) between the slider and electronics external to the slider. However, at least sometimes the other signal and a slider bias voltage are conveyed simultaneously, integrated together with one another, on the same signal path within the slider. Thus, this existing signal path may convey the IVC voltage to slider 110b in an “integral fashion” along with the other signal that is being conveyed to or from the slider on the same signal path. In other implementations, a dedicated signal path may be used to apply a voltage for the IVC to the slider.

In some implementations, the existing signal and/or the IVC voltage is applied through a common mode voltage on a pair of signal lines. The IVC can use a programmable IVC voltage setting (e.g., IVC voltage setting 14 in FIG. 1) to control the IVC voltage generation. As discussed in more detail below, the IVC voltage setting is determined to provide a target electric potential difference between the slider and the disk (e.g., target offset voltage 12 in FIG. 1) that provides a voltage less than the disk voltage to protect components of the slider while ensuring that the electric potential difference between the disk and the slider does not become too large, which could cause too much of an attractive force between the slider and the disk. In some implementations, once the IVC voltage setting is determined, well-known circuit methods are utilized to transfer a digital setting to an analog voltage reference, which is then used for generation of the IVC voltage.

As noted above, slider 110b includes an energy-assisted writer 310 that helps to increase the amount of data that can be magnetically written on the disk by using, for example, HAMR, MAMR, or ePMR. The application of an IVC voltage to the slider, or portions of the slider, can help passivate or electrostatically encapsulate the slider or portions thereof that become more susceptible to additional deterioration caused directly or indirectly by these EAMR technologies. In some implementations, the IVC voltage applied to the slider can be a negative voltage that is less than a disk voltage, which may be a positive disk voltage or a negative disk voltage that is greater than the more negative IVC voltage applied to the slider.

In the case of HAMR, EAW 310 can include a waveguide, a Near Field Transducer (NFT), and an NFT Temperature Sensor (NTS). In such cases, a laser is optically coupled to the waveguide, which guides light from the laser to the NFT to create an intense near-field pattern to heat a recording layer of the disk to temporarily reduce the coercivity (i.e., the magnetic field required to switch a grain or bit in the recording layer). Examples of a HAMR writer configuration can be found in, for example, U.S. Pat. No. 10,910,007, which is assigned to the present applicant and is hereby incorporated by reference herein.

However, the usable life of the NFT is adversely affected by excessive heating of the NFT, which can cause diffusion of the NFT until a tip of the NFT rounds and recording degrades. A voltage, such as a negative voltage, can be applied to the NFT via the SBC to reduce the diffusion or deterioration of the NFT. In other implementations the voltage can be applied via the NTS, which can be connected to the EA+ and EA− pads. In such implementations, the EA+ and EA− pads would also provide an existing signal path for measuring the temperature of the NFT to calibrate the NFT.

In the case of MAMR, EAW 310 can include a Spin Torque Oscillator (STO) in a write gap between a main pole and a trailing shield of the writer. In such cases, the STO generates a high-frequency oscillatory auxiliary magnetic field that is applied to the grains in the recording layer of the disk to make it temporarily easier to write data. Examples of a MAMR writer configuration can be found in, for example, U.S. Pat. No. 10,650,850, which is assigned to the present applicant and is hereby incorporated by reference herein.

However, the STO of the MAMR writer can become oxidized from degradation of the slider protective overcoat. A voltage, such as a negative voltage, can be applied to the STO via the SBC to reduce the oxidation of the STO. In other implementations, the voltage could be applied through the main pole and return pole of the writer, which can be connected to the EA+ and EA− pads. In such Implementations, the EA+ and EA− pads would also provide an existing signal path for activating the STO by supplying an electric current through the main pole, STO, trailing shield, and the return pole, as discussed for MAMR.

In the case of ePMR, EAW 310 can include a conductive layer or metal layer in the write gap between the write pole and the trailing shield of the writer. In such cases, an electric current can be provided through the conductive layer via connections on the main pole and the return pole of the writer to produce a circular magnetic field that is substantially transverse to a magnetization of the write pole when writing data, which increases magnetization reversal that improves the consistency of the write field to increase the signal-to-noise ratio. Examples of an ePMR writer configuration can be found in, for example, U.S. Pat. No. 10,679,650, which is assigned to the present applicant and is hereby incorporated by reference herein.

However, the conductive layer of the ePMR writer can become oxidized from degradation of the slider protective overcoat. A voltage, such as a negative voltage, can be applied to the conductive layer via the SBC to reduce the oxidation of the conductive layer. In other implementations, the voltage could be applied via the main pole and the return pole of the writer, which can be connected to the EA+ and EA− pads. In such implementations, the EA+ and EA− pads would also provide an existing signal path for the current flowing through the conductive layer, as discussed above for ePMR.

Those of ordinary skill in the art will appreciate with reference to the present disclosure that other implementations of slider bias voltage generator 315 and/or slider 110b may differ from FIG. 3. For example, other implementations may include the IVC voltage being applied across different connections than ECS+ and ECS− or may not include certain connections, such as for HE 306 or EAW 310.

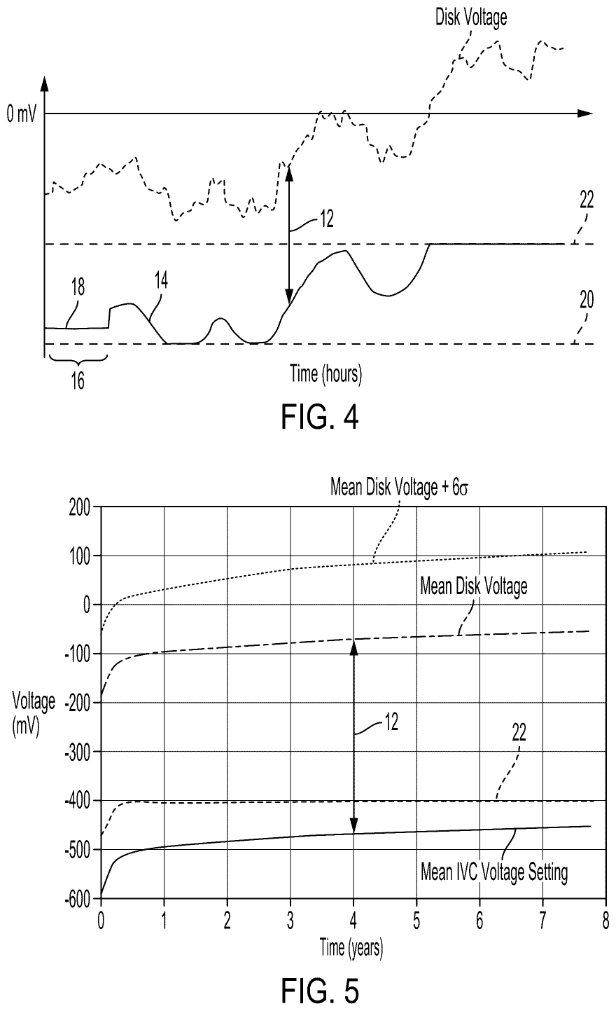

FIG. 4 is a graph showing a voltage applied to a slider over time to maintain a target offset voltage between the slider and a disk voltage according to one or more embodiments. As shown in the example of FIG. 4, the disk voltage shown by the dashed line varies over time. The IVC voltage setting 14 adjusts over time to track the changes in disk voltage, while maintaining a target offset voltage 12 or electric potential difference between the slider and the disk with the IVC voltage setting being lower than the disk voltage by the target offset voltage. In some implementations, the magnitude of target offset voltage 12 can be a fixed value within the range of 100 mV to 700 mV, and preferably, within the range of 200 mV to 600 mV. The magnitude of target offset voltage 12 can depend on a physical arrangement of the slider and/or the disk, such as settings or specifications for an operating fly height of the slider, to provide a relatively large negative voltage to the slider while safeguarding against too great of an attractive electrostatic force that could cause contact between the disk and the slider.

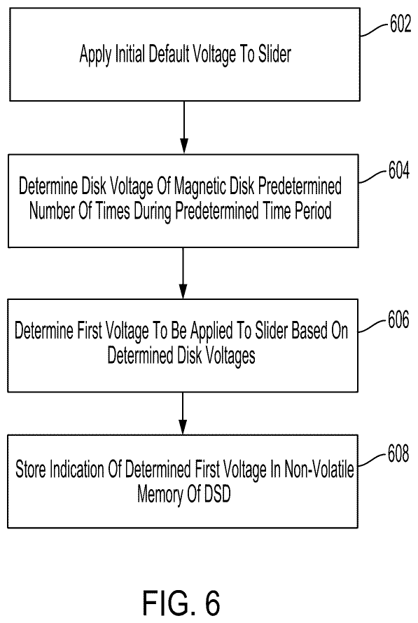

During an initial period of time 16, a default IVC voltage setting can be used. In some implementations, the default IVC voltage setting can be based on measurements made at the factory for the DSD or for a particular model of DSD. As discussed in more detail below with reference to the initial slider voltage setting process of FIG. 6, the initial period of time 16 can be used to determine a disk voltage of the magnetic disk a predetermined number of times (e.g., eight times during a first eight hours of operation). After determining the disk voltage for the predetermined number of times, the IVC voltage setting can be adjusted from the default IVC voltage setting based on at least a portion of the measured or determined disk voltages during the initial time period.

The DSD may then periodically update its measurement or determination of the disk voltage (e.g., every eight hours of operation) to determine a new IVC voltage setting or maintain the same IVC voltage setting so that the IVC voltage setting 14 remains approximately less than the measured or determined disk voltage by target offset voltage 12. Notably, this can often enable a lower voltage to be applied to the slider than would otherwise be used by the default voltage setting, which can further improve the usable life of the slider and its components.

As shown in the example of FIG. 4, an upper voltage limit 22 and a lower voltage limit 20 may limit the range for IVC voltage setting 14. These limitations can result from limitations of the circuitry of the DSD in some implementations and/or may be set based on an estimated range of variation for the disk voltage and to safely avoid contact between the slider and the disk due to an attractive electrostatic force. FIG. 5 discussed in more detail below provides an example of setting upper voltage limit 22 based on an estimated highest disk voltage. Notably, IVC voltage setting 14 maintains a negative voltage (i.e., below 0 mV) in FIG. 4 to prolong the life of the slider.

FIG. 5 is a graph showing an average voltage applied to sliders in a DSD over a long timeframe to maintain a target offset voltage between the sliders and an average disk voltage according to one or more embodiments. In some implementations, the mean or average disk voltage can represent disk voltages determined for many disks within a single DSD. In other implementations, the mean or average disk voltage can represent disk voltages determined for a large set of DSDs, such as for a particular model of DSD.

As shown in FIG. 5, the timescale is in terms of years and the mean disk voltage has a gradually increasing voltage over time. This upward drift in disk voltage causes a corresponding upward drift in the mean IVC voltage setting, such that the target offset voltage 12 is generally maintained between the mean disk voltage and the mean ICV voltage setting.

In some implementations, upper voltage limit 22 for the IVC voltage setting (e.g., IVC voltage setting 14 in FIG. 1) can be determined based on six standard deviations above the mean disk voltage to reflect a worst case or highest estimated disk voltage to ensure a safe electric potential difference between the disk and the slider when the IVC voltage is at upper voltage limit 22 to prevent contact between the disk and the slider due to too great of an electric potential difference.

This limit for the electric potential difference between upper voltage limit 22 and the highest estimated disk voltage can be greater than target offset voltage 12, as shown in FIG. 5. For example, target offset voltage 12 can be set to 400 mV and the difference between the six standards of deviation above the mean disk voltage at year seven and upper voltage limit 22 at year seven can be 500 mV. This electric potential difference between the upper voltage limit and the highest estimated disk voltage at a particular time (e.g., at year seven) may also include a factor of safety, such as where a 600 mV electric potential difference would cause a slider to contact a disk surface, but upper voltage limit 22 is set for a 500 mV electric potential difference below the six standards of deviation above the mean disk voltage at a particular time, such as at year seven.

Those of ordinary skill in the art will appreciate with reference to the present disclosure that other implementations of setting an upper voltage limit or estimating a highest disk voltage may differ. For example, other implementations may use a different number of standard deviations above a mean disk voltage to estimate a highest disk voltage or may use a different point in time for determining the upper voltage limit, such as the fifth year of operation as opposed to the seventh year of operation. In addition, the voltage values for the mean disk voltage, the target offset voltage, and the corresponding average IVC voltage setting may differ in other implementations.

### Example Processes

FIG. 6 is a flowchart for an initial slider voltage setting process according to one or more embodiments. The process of FIG. 6 can be performed by, for example, circuitry 166 of DSD 100 executing IVC module 10 in FIG. 1. In this regard, circuitry 166 and/or other circuitry of DSD 100 such as R/W IC 305 or slider bias voltage generator 315 in FIG. 3 can, in some implementations, comprise a means for performing the functions of the initial slider voltage setting process of FIG. 6.

In block 602, the circuitry applies a starting default voltage to a slider. The default voltage can correspond to, for example, a fixed value (e.g., −600 mV) that is based on testing performed on other DSDs and/or factory testing of the particular DSD.

In block 604, the circuitry determines a disk voltage or an OIV for a predetermined number of times in a predetermined time period. This time period can correspond to time period 16 in the example of FIG. 4. During this time period, the circuitry may measure or determine the disk voltage at a fixed period, such as every six or eight hours of operation. The determination of the disk voltage can result from indirectly measuring the fly height of the slider, such as by monitoring head-disk spacing signals using Wallace spacing loss signals or dual harmonic sensing. For example, a series of input voltages can be applied by a slider bias voltage generator within a range of voltages while the slider flies over the disk to monitor the head-disk spacing signals and then determine the voltage that provides the greatest fly height and a corresponding lowest amplitude for a signal, such as a read signal or ECS signal. In some implementations, the head-disk spacing signals can be monitored during a single revolution of the disk. The voltage corresponding to the greatest fly height generally provides a zero electric potential difference between the slider and the disk, and therefore represents the disk voltage or conventional OIV.

In block 606, a first voltage to be applied to the slider after using the default voltage during the predetermined time period is determined based on at least a portion of the disk voltages determined in block 608. In some implementations, a filter may be applied to the predetermined number of determined voltages to filter out any voltages outside of an upper and/or lower voltage limit and the remaining predetermined voltages can be averaged to provide a filtered average disk voltage. The target offset voltage (e.g., 400 mV) may then be subtracted from this filtered average voltage to provide the first voltage to be applied to the slider.

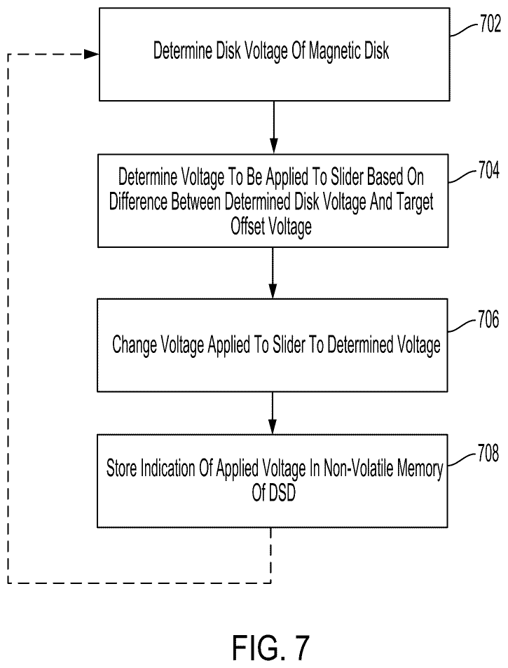

In block 608, an indication of the determined first voltage can be stored in a non-volatile memory of the DSD, such as NVM 174 in FIG. 1. If the DSD is powered off, the stored indication of the first voltage can then be used as the IVC voltage to be applied to the slider after the DSD is powered back on. The circuitry of the DSD can also apply the first voltage to the slider in block 608, such as via slider bias voltage generator 315 in FIG. 3. As discussed in more detail below with reference to FIG. 7, subsequent measurements or determinations of a disk voltage may occur over time and the voltage applied to the slider may be adjusted from the first voltage to compensate for changes in the disk voltage and attempt to maintain the target offset voltage between the slider and the disk.

Those of ordinary skill in the art will appreciate with reference to the present disclosure that other ways of determining a first or initial voltage setting are possible. For example, in other implementations, the determination of the first voltage to be applied to the slider may occur after a single measurement or determination of the disk voltage, as opposed to requiring a predetermined number of measurements or determinations of the disk voltage during a predetermined period of time. In addition, those of ordinary skill in the art will appreciate with reference to the present disclosure that the process of FIG. 6 may be performed for each slider in a DSD. In this regard, it is possible for the voltage of the magnetic disk to vary on its opposite sides.

FIG. 7 is a flowchart for a repeating slider voltage setting process according to one or more embodiments. The process of FIG. 7 can be performed by, for example, circuitry 166 of DSD 100 executing IVC module 10 in FIG. 1. In this regard, circuitry 166 and/or other circuitry of DSD 100 such as R/W IC 305 or slider bias voltage generator 315 in FIG. 3 can, in some implementations, comprise a means for performing the functions of the repeating slider voltage setting process of FIG. 7. The process of FIG. 7 may be performed after an initial determination of a voltage to apply to the slider, such as after the first slider voltage setting process of FIG. 6.

In block 702, a disk voltage or conventional OIV is determined for a magnetic disk. The determination of the disk voltage can result from indirectly measuring the fly height of the slider, such as by monitoring head-disk spacing signals using Wallace spacing loss signals or dual harmonic sensing, as discussed above.

In block 704, a voltage to be applied to the slider is determined based on a difference between the disk voltage determined in block 702 and the target offset voltage. With reference to the example of FIG. 2A discussed above, the disk voltage may be determined to be −200 mV corresponding to FH₂ having the greatest fly height. If the target offset voltage is 400 mV, the voltage to be applied to the slider would be −600 mV to obtain the target offset voltage below the determined disk voltage.

In block 706, the voltage applied to the slider is changed from a currently applied voltage to the voltage determined in block 704. An indication of the new applied voltage can be stored in a non-volatile memory of the DSD in block 708. If the DSD is powered off, the stored indication of the voltage can then be used as the IVC voltage to be applied to the slider after the DSD is powered back on. The process of FIG. 7 may then be repeated after a predetermined period of time (e.g., after eight hours of operation) by returning to block 702 to again determine the disk voltage of the magnetic disk.

Those of ordinary skill in the art will appreciate with reference to the present disclosure that other implementations of the repeating slider voltage setting process of FIG. 7 may differ. For example, in some implementations the voltage applied to the slider may not be stored in a non-volatile memory of the DSD such that after a restarting of the DSD, a default voltage may instead be used until the process of FIG. 7 is performed. In addition, those of ordinary skill in the art will appreciate with reference to the present disclosure that the process of FIG. 7 may be performed for each slider in a DSD.

The foregoing systems and methods for applying a voltage to a slider that is less than a disk voltage can increase the lifespan of sliders and their components by applying a greatest lower voltage to the slider within a margin of safety provided by the target offset voltage to reduce the likelihood of contact between the slider and the disk. In addition, the voltage can be adjusted throughout the operating life of the DSD to continue to provide as much of a lower voltage as possible within the margin of safety provided by the target offset voltage as the voltage of the disk changes over long periods of time.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general purpose processor, a GPU, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

1. A Data Storage Device (DSD), comprising:
a magnetic disk;
a slider including a writer configured to magnetically write data on the magnetic disk; and
circuitry configured to apply a voltage to the slider to provide a non-zero target offset voltage between the slider and the magnetic disk, wherein the voltage applied to the slider differs from a disk voltage of the magnetic disk.

2. The DSD of claim 1, wherein the voltage applied to the slider differs from the disk voltage by at least 100 mV.

3. The DSD of claim 1, wherein the circuitry is further configured to:
determine a first disk voltage of the magnetic disk; and
determine the voltage to be applied to the slider based on a difference between the determined first disk voltage and the target offset voltage.

4. The DSD of claim 3, wherein the circuitry is further configured to:
determine a second disk voltage of the magnetic disk at a time after the determination of the first disk voltage;
determine a new voltage to be applied to the slider based on a difference between the determined second disk voltage and the target offset voltage; and
change the voltage applied to the slider to the determined new voltage.

5. The DSD of claim 1, wherein the circuitry is further configured to store an indication of the applied voltage in a non-volatile memory of the DSD.

6. The DSD of claim 1, wherein a magnitude of the target offset voltage is in a range of 100 mV and 700 mV.

7. The DSD of claim 1, wherein the voltage applied to the slider is limited by at least one of a lower threshold value and an upper threshold value.

8. The DSD of claim 1, wherein the writer is an energy-assisted writer configured to use Microwave-Assisted Magnetic Recording (MAMR), energy-assisted Perpendicular Magnetic Recording (ePMR), or Heat-Assisted Magnetic Recording (HAMR); and
wherein the voltage applied to the slider reduces deterioration of the slider caused by operation of the energy-assisted writer.

9. The DSD of claim 1, wherein the circuitry is further configured to:
apply an initial default voltage to the slider;
determine a disk voltage of the magnetic disk a predetermined number of times within a predetermined time period; and
determine a first voltage to be applied to the slider based on at least a portion of the predetermined number of determined disk voltages.

10. A method of controlling a voltage applied to a slider of a Data Storage Device (DSD), the method comprising:
determining a first disk voltage of a magnetic disk of the DSD;
based on the determined first disk voltage, determining a voltage to be applied to the slider to adjust an electric potential difference between the slider and the magnetic disk to provide a non-zero target offset voltage; and
applying the determined voltage to the slider.

11. The method of claim 10, wherein the target offset voltage has a magnitude of at least 100 mV.

12. The method of claim 10, wherein the determined voltage is less than the first disk voltage of the magnetic disk.

13. The method of claim 10, further comprising determining the voltage to be applied to the slider based on a difference between the determined first disk voltage and the target offset voltage.

14. The method of claim 10, further comprising:
determining a second disk voltage of the magnetic disk at a time after the determination of the first disk voltage;
determining a new voltage to be applied to the slider based on a difference between the determined second disk voltage and the target offset voltage; and
changing the voltage applied to the slider to the determined new voltage.

15. The method of claim 10, further comprising storing an indication of the determined voltage in a non-volatile memory of the DSD.

16. The method of claim 10, wherein a magnitude of the target offset voltage is in a range of 100 mV and 700 mV.

17. The method of claim 10, wherein the determined voltage has a negative value.

18. The method of claim 10, wherein the slider further includes an energy-assisted writer configured to use Microwave-Assisted Magnetic Recording (MAMR), energy-assisted Perpendicular Magnetic Recording (ePMR), or Heat-Assisted Magnetic Recording (HAMR); and
wherein the determined voltage applied to the slider reduces deterioration of the slider caused by operation of the energy-assisted writer.

19. The method of claim 10, further comprising:
applying an initial default voltage to the slider;
determining a disk voltage of the magnetic disk a predetermined number of times within a predetermined time period; and
determining a first voltage to be applied to the slider based on at least a portion of the predetermined number of determined disk voltages.

20. A Data Storage Device (DSD), comprising:
a magnetic disk;
a slider including a writer configured to magnetically write data on the magnetic disk; and
means for applying a voltage to the slider to provide a non-zero target offset voltage between the slider and the magnetic disk, wherein the voltage applied to the slider differs from a disk voltage of the magnetic disk.
